(19) United States
(12) Patent Application Publication
(10) Pub. No.: US 2005/0041654 A1
(43) Pub. Date: Feb. 24, 2005

(54) Multi-dimensional disconnected mesh switching network

(76) Inventor: Hee-Choul Lee, Cupertino, CA (US)

Correspondence Address: MARGER JOHNSON & MCCOLLOM PC, 1030 SW MORRISON STREET, PORTLAND, OR, 97205, US

(21) Appl. No.: 10/645,890

(22) Filed: Aug. 20, 2003

(51) Int. Cl. H04L 12/50

(52) U.S. Cl. 370/386

(57) ABSTRACT

An n-dimensional broken mesh network in which input output protocol processing block is connected to a broken link and external traffic link is connected to the input output protocol processing block. Broken link is formed by breaking connection between a starting switching element and an ending switching element of each dimension in mesh network.

### BACKGROUND OF THE INVENTION

1. Field of the Invention

The present invention relates to switching network and more specifically to a fault tolerant multi-dimensional disconnected mesh switching network for high speed large scale efficient packet switching.

2. Description of the Related Art

High speed packet switching is a key technology for Broad-band Integrated Services Digital Network (B-ISDN). Currently, Asynchronous Transfer Mode (ATM) is receiving tremendous attention for the next generation of communication technology. The ATM was defined by the CCITT (currently ITU-T) which is the United Nations (U.N) body which defines future telecommunication standards. The basic Protocol Data Unit (PDU) of ATM, which is called a cell, has a fixed length of 53 bytes. ATM switching can be classified as part of the larger category packet switching.

The high speed packet switch is a key technology for B-ISDN technology. There are many requirements for the architecture of a high speed packet switch, such as a modularity and high fault-tolerance, which contribute to easy implementation and good quality of service. Such technology is disclosed in “ATM Technology for Corporate Networks”, IEEE Communications Magazine, pages 90-101, April, 1992.

A packet switch is a system that is connected to multiple transmission links and does the central processing for the activity of a packet switching network where the network consists of switches, transmission links and terminals. The transmission links are connected to network equipment, such as multiplexers (MUX) and demultiplexers (DMUX). A terminal can be connected to the MUX/DMUX or it can be connected to the packet switch system. Generally, the packet switch consists of input and output transmission link controllers and the switching network. The input and output link controllers perform the protocol termination traffic management and system administration related to transmission jobs and packet transmission. These controllers also process the packets to help assist in the control of the internal switching of the switching network. The switching network of the packet switch performs space-division switching which switches each packet from its source link to its destination link.

There are many known architectures for switching networks. The important characteristics for a switching network are self-routing for high speed switching, short transmission delays, low delay variance, good fault tolerance for high quality service, and high reliability for easy maintenance. Generally, the switching networks are composed of several switching stages with a web of interconnections between adjacent stages. These networks are called Multi-stage Interconnection Networks (MIN). Each stage consists of several basic switching elements where the switching elements perform the switching operation on individual packets for self-routing of the packets. Self-routing enables each packet to be processed by the distributed switching elements without a central control scheme, and thus high speed switching can be done.

FIG. 1 shows a conventional two dimensional mesh computer network system 100 with nine computation nodes 110. In the conventional two dimensional mesh network system 100, horizontally arranged nodes are connected to form a horizontal loop 150 and vertically arranged nodes are connected to form a vertical loop 160. Each node comprises a switching element and a processing element connected to the switching element. Each switching element in FIG. 1 has five inputs and five outputs. Four input and output ports are used for global message transfer and the other one input/output port is used for the message transfer from/to the local processing element. The message or data exchange among the nodes for parallel processing happens through the connected wires.

While this network structure works well for small network, it becomes increasingly inefficient as the size of a network increases because mean number of hops between a source and sink increases proportionally with the number of nodes per loop.

In contrast to the computer network system 100, the telecommunication switching system uses only switching elements without local processing element. The most well known switching system is Clos network 200 in FIG. 2 where input switches (first stage) 210 are connected to output switches (third stage) 230 by middle stage switches 220.

The Clos network 200 does not have any local input/output ports for local processing element. The processing elements are in the front of first stage 210 or at the end of third stage 230. So the number of local input link is n×g and the local output link is also n×g.

However, in the Clos network 200, the number middle stage switches 220 should be greater than 2×n, to be non-blocking. Accordingly, it becomes increasingly inefficient as the size of a network increases

Omega network consists of n switching stages (where n=log₂N stages with N being the number of input ports and the number of input ports, i.e. the number of input and output ports being the same is a “square size” network). Each of the n switching stages is composed of N/2 basic switching elements and each switching element performs 2×2 switching. In Omega switching network there is only one path to one source and destination pair. Accordingly, if a connection becomes faulty, then some traffic will be lost. Further more, as the size of the network increases, switching time for transferring date or information increases.

FIG. 3 shows a 8×8 Omega switching network 300. The input link 341 and output link 342 have a different protocol from the internal link 343. Generally the input packets are reformatted to have internal header information for self-routing in the input protocol processor 310 and output protocol processor 320. The internal switching network 350, so called fabric, has all same protocol connections 343. There are two times protocol conversions in the switching system 300; one from input link 341 to internal link 343 and the other from internal link 343 to output link 342. These conversions happen in the input protocol processor 310 and output protocol processor 320. These protocol processors 310 and 320 decouple one side protocol from the other side protocol. In the FIG. 3, if a connection becomes faulty, then some traffic will be lost because there is only one path to one source and destination pair, so it is not fault tolerant.

European patent application number EP 1 76770A2 by Beshal et al., discloses multi-dimensional lattice network comprise a plurality of sub-net 400 as shown in FIG. 4. In each sub-net 401, input/output links 402 interconnect data source and sink with edge switch (edge module) 408. The edge modules 408 are in turn connected to N core stages 414 by core links 412. Because source and sink are connected by the edge modules 408, total traffic amount increases proportionally with the muti-dimensional system volume. However, it requires a plurality of core stages 414 (core switches).

Fault tolerant becomes more important when the system becomes bigger and it is used by more people. The backbone switching systems switching all data in one city should be designed with high fault tolerance and high reliability.

Accordingly, there is a need for a cost effective, fault tolerant, and a robust system at any traffic load variation.

### SUMMARY OF THE INVENTION

One exemplary embodiment of the present invention is directed to a multi-dimensional disconnected mesh switching network where local data source and sink are connected to a broken links by input and output protocol processor. The disconnected mesh network can be called as a lattice switching network, which has local connections on the surface of the network physical shape.

In one embodiment of present invention, the switching elements have more connections to provide some shortcut paths to the destination port. The shortcut path could be a diagonal connection to an adjacent switching element or it could be an arbitrary length to a far apart switching element.

The open shortcut (jumping) connections of boundary switching element or located nearby the boundary provide more input output ports, some of them can be used for the increase of fault tolerance by providing extra connections.

The present invention will be more fully understood in the view of the following descriptions and drawings.

### BRIEF DESCRIPTION OF THE DRAWINGS

FIG. 1 is a schematic diagram of a conventional two dimensional mesh network.

FIG. 2 is a schematic diagram of a conventional Clos network.

FIG. 3 is a schematic diagram of a conventional Omega switching network.

FIG. 4 is a schematic diagram of a sub-net of edge modules interconnect by a core switch according to a prior art.

FIG. 5 is a schematic diagram of a two dimensional disconnected mesh network according to the present invention.

FIG. 6 is a schematic diagram of a three dimensional disconnected mesh network with 54(6×9) IO links according to the present invention.

FIG. 7 is a schematic diagram of a two dimensional disconnected mesh network with diagonal jumping routes in the FIG. 5.

FIG. 8 is a schematic diagram of a two dimensional disconnected mesh network with diagonal jumping routes and control processors in the FIG. 5.

FIG. 9 schematically illustrates relative location propagation steps in the two dimensional invented network according to the present invention.

FIG. 10a is a schematic diagram of two dimensional broken mesh network with reduced number of switching elements, while the number of IO links is maintained same when there is no jumping route in the FIG. 5 and FIG. 10b is a schematic diagram of two dimensional broken mesh network with reduced the number of switching elements, when there are jumping routes in the FIG. 5.

FIG. 11 is a schematic diagram of a derived multiplexer and demultiplexer from the basic switching elements according to the present invention.

FIG. 12 is a schematic diagram of a switching system with several multiplexers and de-multiplexers on the surface of switching block to make the traffic load low according to the present invention.

FIG. 13 schematically illustrate six different routing paths from (k, l) switching element to (k+2, l+2) switching element in FIG. 5.

FIG. 14 schematically illustrates an example of bypassing path for a faulty switching element in the FIG. 5.

FIG. 15 schematically illustrates an example of detouring path to avoid the hot-spots in the FIG. 5.

FIGS. 16a and 16b schematically illustrate a packet formats passing through the invented switching system.

FIG. 17 schematically illustrates how data packet is changed during self-routing via routing path \mathring{2} in FIG. 13.

FIG. 18a is a schematic diagram with reduced switch elements in the central part in FIG. 5

FIG. 18b is a schematic diagram with tweaked interconnection in FIG. 5

FIG. 18c is a schematic diagram with irregular connection and with reduced switching element in FIG. 5.

FIGS. 19a and 19b is a schematic diagram of a system with reduced number wires for jumping routes.

FIG. 20 schematically illustrates connecting two 2-dimensional switching systems using broken local links.

FIG. 21 is a schematic architecture of 4×4 switching element with input and output buffers, which monitors the output buffer level and reports the overload of output buffers.

FIG. 22 schematically illustrates traffic load controlling by the traffic control processor collecting the overload information of output buffers at each switching element.

FIG. 23 schematically illustrates the information retrieval of the source links passing through the overloading output buffer.

FIG. 24 is a schematic algorithm selecting a reasonable path for traffic load balancing.

FIG. 25 schematically illustrates configurable module board design for rack style system installation.

FIG. 26 schematically illustrates an example of invented system with three dimensional housing.

FIG. 27 schematically illustrate work space for fault module replacement and air flow for system cooling in the three dimensional housing.

FIG. 28 schematically illustrates three dimensional housing in FIG. 26 with switching board and socket and guide means for guiding exchange apparatus.

### DETAILED DESCRIPTION

All known switching systems have some problems in performance or too expensive to implement. Specifically the number of switching elements needs to be decreased. And the ratio of available number of input/output ports over total number of internal and external connections should be improved. The present invention uses the surface connections of broken multi-dimensional mesh network; it can be called a lattice network, which has input and out ports on the surface of the network system volume.

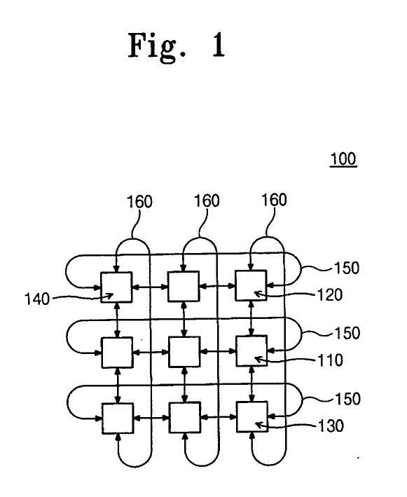

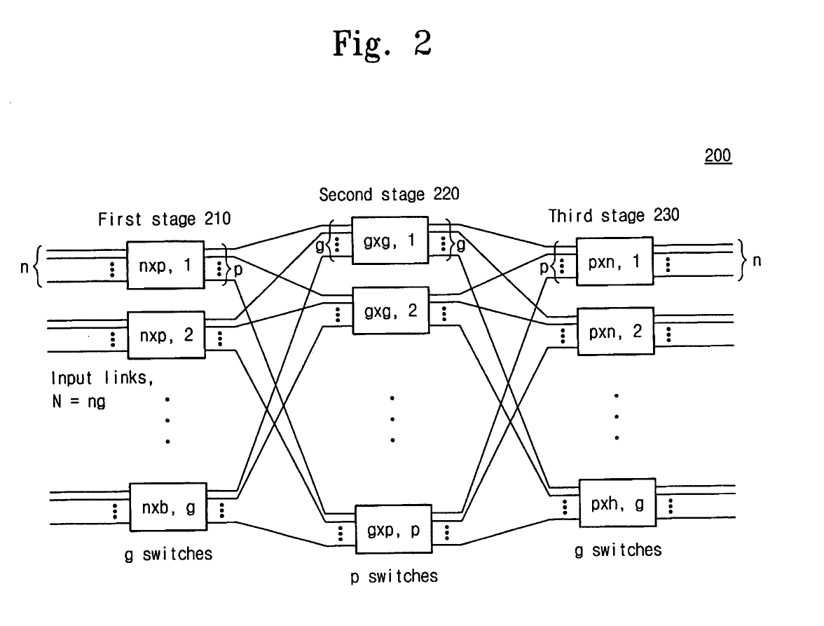

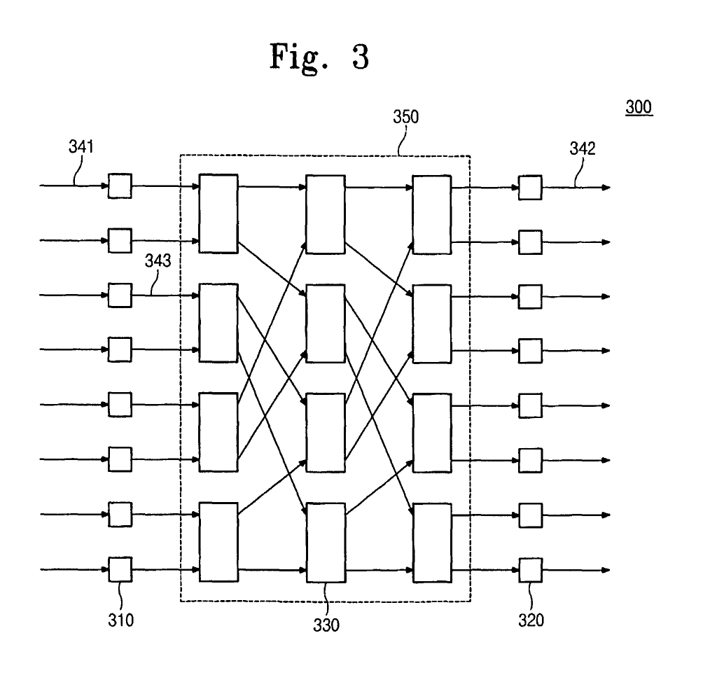

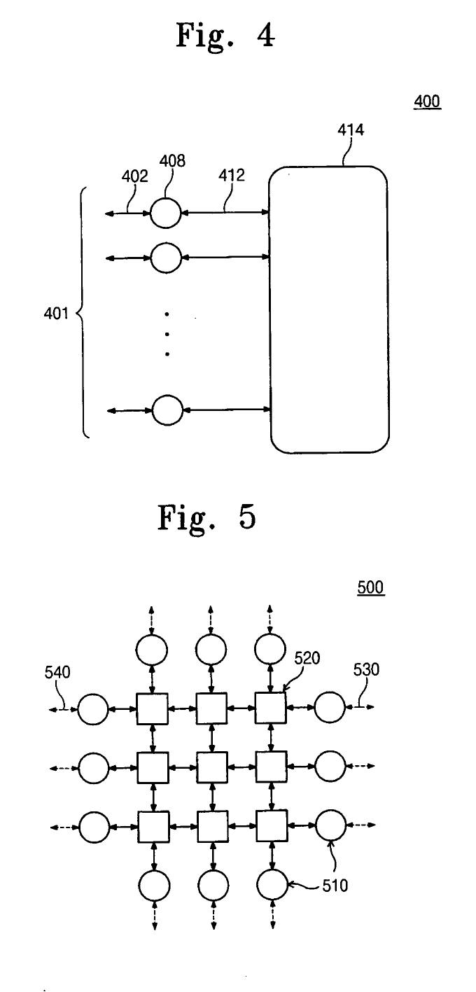

A conventional mesh network can be expressed N nodes, where each node has a n-tuple coordinates, (d₁, d₂, . . . , dₙ). There are connections between the adjacent nodes, which have n−1 same coordinates and the difference of the one different coordinate is plus minus 1, ±1. Another special connection is the connection between the ending node to the starting node at each dimension. For example, the two dimensional mesh network 100 of FIG. 1 has 9 nodes and each node has 4 connections. Each node can be expressed by two-tuple coordinates, (x,y). The y-dimensional and x-dimensional ending node 120 has connection with the y-dimensional starting node 130 and x-dimensional starting node 140. Such interconnection connecting starting node and ending node is so called wrap-around link. When the each connection in the mesh network is unidirectional, the mesh network is called as an unidirectional mesh network. It is called bidirectional mesh network if each connection has bidirectional connections.

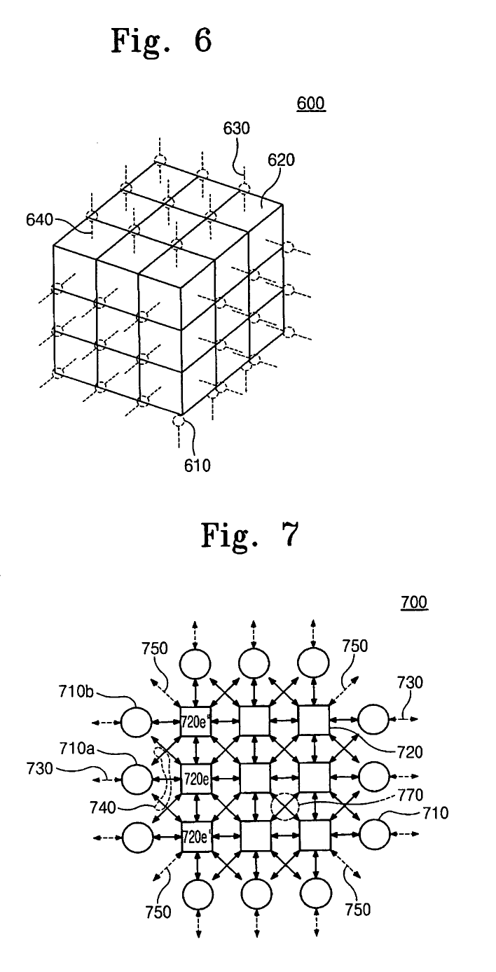

Referring to FIGS. 5 and 6, multidimensional broken mesh network is described.

FIG. 5 shows two dimensional broken (or disconnected) mesh network 500 where the input/output protocol processor 510 converts the input/output link protocol to internal link protocol 540. Unlike conventional mesh network 100 of FIG. 1, a basic switching element 520 does not have connection to the local traffic source or sink. All traffic sources and sinks 530 are connected on the boundary of the broken mesh network 500. Input and output protocol processors 510 connect the basic switching element 520 and traffic source and link 530.

In FIG. 5, there are 9 switching elements 520 and 12 bidirectional traffic links 530. The possible longest routing path contains 5 switching elements, when the routing method is assumed to choose the shortest path.

The difference of FIG. 5 from conventional mesh network in FIG. 1 is that the wrap-around connection 150, 160 connecting the starting node and the ending node is disconnected and the end points of the disconnected links are connected to the input output protocol processor 510.

When two dimensional broken (or disconnected) mesh network 500 of FIG. 1 is expanded into n dimensional broken mesh network, the n dimensional broken mesh network is composed of N switching elements, each switching element has its own n-tuple coordinates, expressed (d₁, d₂, . . . , dₙ). Where d₁ can vary from 1 to D₁, and d₂ can vary from 1 to D₂, and so on. The total number of switching nodes, N, is obtained D₁×D₂× . . . ×Dₙ. Each switching node has 2×n connections to the adjacent nodes, which has (n−1) same coordinates and the other one coordinate different from the switching node by ±1. There are 2×n disconnected surfaces of the normal mesh network and each surface has several disconnected links. The traffic trunk or link is connected to the disconnected links. There are two surfaces for one dimensional axis, for example, the surface nodes of k-th dimension have coordinates (d₁, d₂, . . . , dₖ=1 . . . , dₙ) or (d₁, d₂, . . . , dₖ=Dₖ . . . , dₙ), where d₁ can vary from 1 to D₁, and d₂ can vary from 1 to D₂, and so on. And the number of links for k-th dimensional surface are 2×(D₁×D₂×Dₖ₋₁×Dₖ+1×Dₙ).

FIG. 6 shows a three dimensional disconnected mesh network 600 with 54 external links 630. The three dimensional disconnected mesh network 600 has 27 switching elements implementing 6×6 switching. Each switching element has 6 bidirectional links and thus there are 27×6 bidirectional connections from all switching elements; 54 connections are used for external traffic trunks and 108 connections are used for internal connections between switching elements. The percentile of external links among total switching connections reaches 33 percent.

As described in FIG. 5, in FIG. 6, 27 broken wrap-around links are connected to 54 (2×27) external links 630 through input and output protocol processors 610.

To reduce the routing delay in the broken mesh switching network, FIG. 7, shows a shortcut routing 770, so called jumping route, into diagonal direction. Each switching element 720 has 8 connections 720 (In FIG. 5, each switching element has 4 connections). The increased jumping routes 770 reduce the longest routing path in the switching system. The longest routing path in FIG. 7 passes through 3 switching elements. The external data link 730 connected to input output protocol processor 710a has 3 internal connections 740 compared to 1 connection in FIG. 5. These extra connections can be used for the higher fault tolerance. Even when one of the three internal links is out of order, the system can operated without any serious problem. These extra connections, also, prevent a system fault even though the nearest switching element 720e to the switching element 710a goes out of order by allowing communication to the adjacent switching elements 720e′, 720e″. The introduction of diagonal jumping route introduces dangling diagonal link 750, which can be used for system control purpose or for extra input output external data links.

The jumping route can be defined several ways. The example shown in FIG. 7, has jumping route connections between two nodes having n−2 same coordinates and the difference of the other two different coordinates are ±1. For the efficiency of invented switching network, arbitrary jumping route can be added.

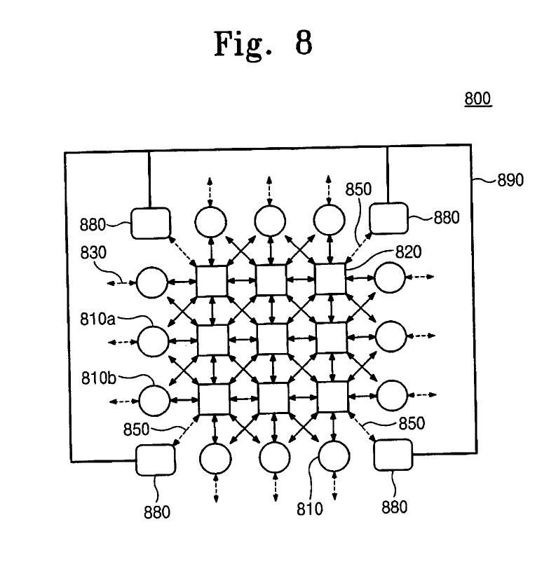

FIG. 8 shows four system traffic control processors 880 to the dangling diagonal links 75, 850. These processors 880 are also connected each another by the control system bus 890, through which the system information are synchronized among the control processors. All switching elements 820 reports its over-loading situation to the nearest control processor assigned to each switching element. For the higher system fault tolerance, the control system bus also can be duplicated.

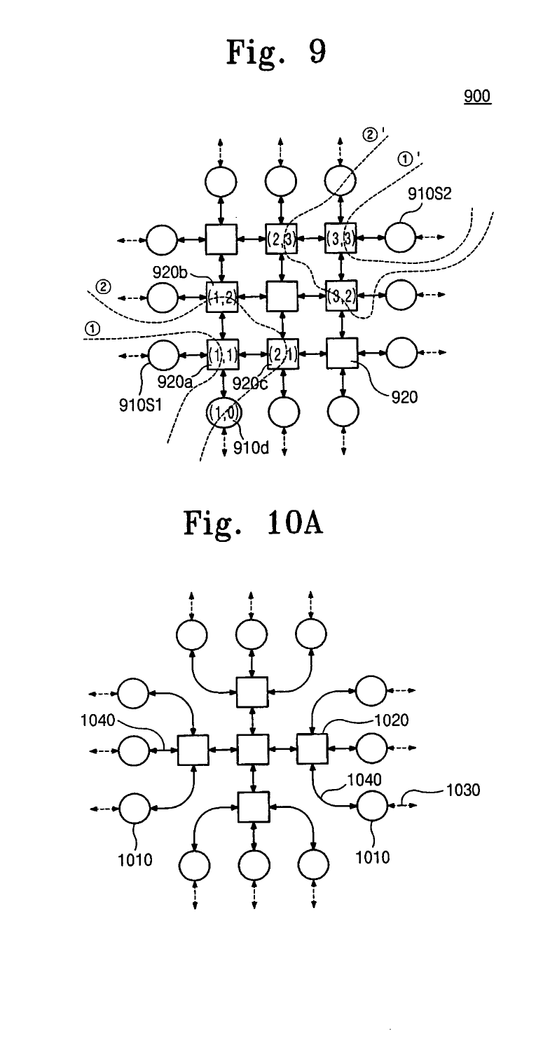

FIG. 9 shows how the coordinates of each switching elements can be defined at the system booting time. In the complex modular switching system, physically defining the location coordinates will make the system more complex. The solution is a dynamic location propagation approach from some fixed locations or assigning the location information from system control processor attached somewhere in the switching nodes. There are two starting points 910s1 and 910s2. By propagating the location allocation message, the wave front nodes are assigning their coordination value. After one message transfer period, the first nodes on the propagation line will assign their coordination number and at the next location message transfer period the location information are propagated to nodes on the second propagation line. Namely, at first, coordinate value (1, 1) is allocated to a switching element 920a which is connected to the starting processor 910s1 (see wave \mathring{1}). After node on the wave \mathring{1}, switching element 920a, is determined, location allocation message is propagated into front nodes 920b, 920c, 910d, i.e., switching elements 920c, 920b and protocol processor 910d based on the switching element 920a.

Based on the description of this invention in previous pages, further embodiments can be implemented.

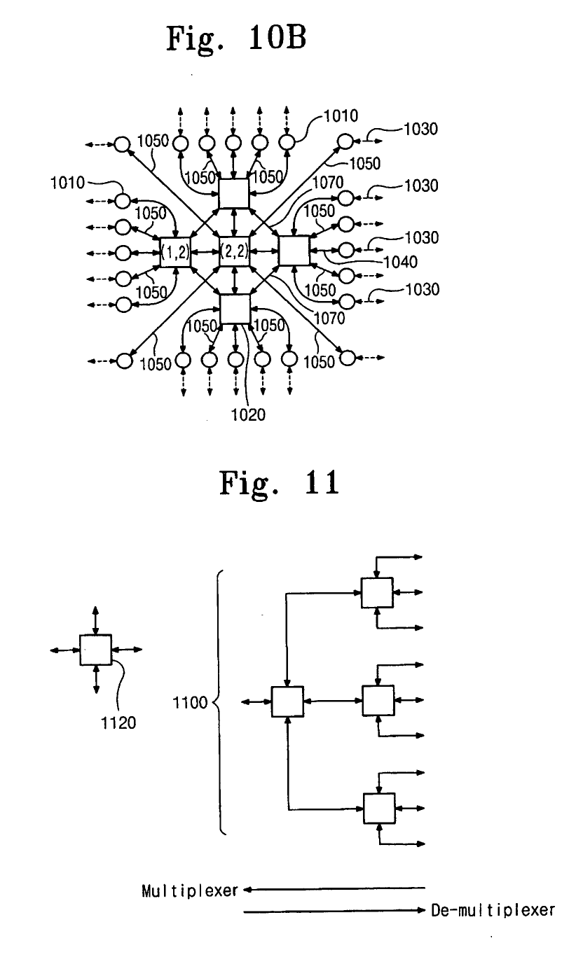

FIGS. 10a and 10b shows how to reduce the number of switching elements from the basic disconnected mesh network. In FIG. 10a, some corner nodes are removed from original two dimensional disconnected mesh network 500 of FIG. 5. Each corner nodes 1020 is connected to 3 input and output protocol processors 1010.

FIG. 10b shows the switching network after reducing the corner nodes and using each dangling nodes as a one external traffic link. There are 5 switching elements 1020 implementing 8×8 switching and 24 external links 1030. The percentile of external links among total connection links reaches 60 percent.

The basic switching elements developed for the invented disconnected mesh network can be used several different ways. FIG. 11 shows multiplexer and de-multiplexer application of the switching element. A 4×4 switching element 1110 can be connected as 1120 with bidirectional internal links. When a traffic data or packet moves into right, the system 1100 works as a de-multiplexer or distributor. When a traffic data moves into left, the system 1100 works as a multiplexer or concentrator of traffic.

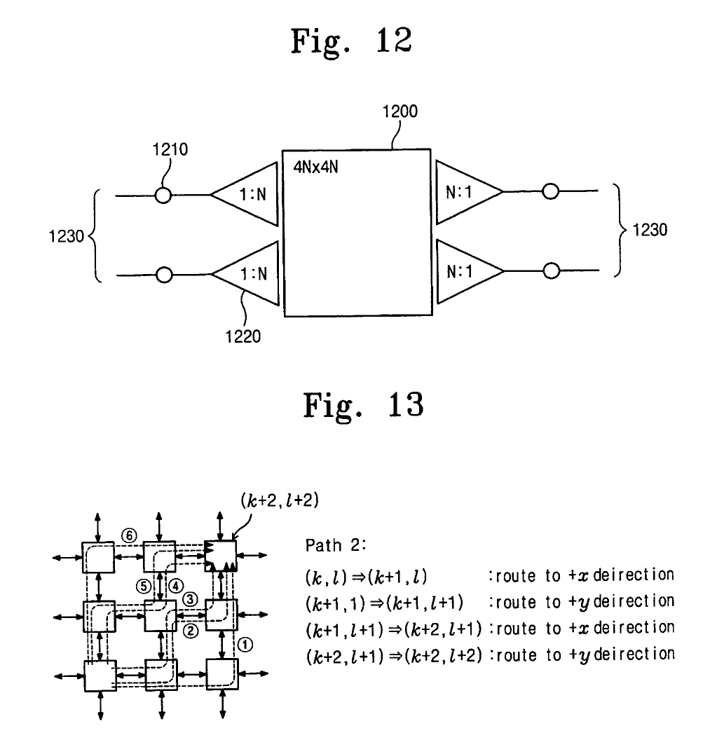

FIG. 12 shows how the multiplexer and de-multiplexer can be used to deal with high speed traffic trunk. The input output protocol converter 1210 receives high speed traffics 1230 and the multiplexer/de-multiplexer 1220 distributes/collects into/from lower rate traffic links. This multiplexer/de-multiplexer 1220 reduces the traffic load in each link of the switching system 1200. So that the system can handle high speed traffic links without any bottleneck by using more switching resources. The capacity of the switching fabric is 4N×4N, because each link at both sides is bidirectional. When the capacity of switching fabric is expressed in high speed traffic link 1240, it is 4×4 high speed trunk capacities.

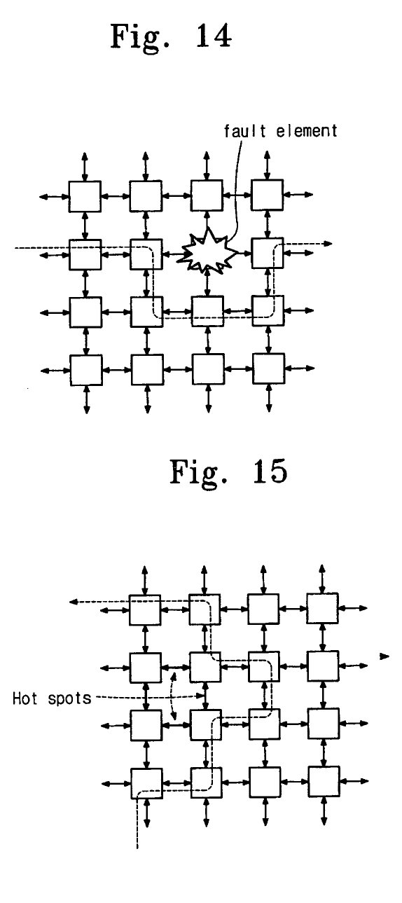

The fault tolerance of invented system is inherited from the many possible ways of routing even without the jumping routes 730 of FIG. 7. FIG. 13 shows 6 routing paths from the switching element, (k,l) to the switching element, (k+2,l+2). A message following path 2 passes the switching elements, (k+1,l), (k+1,l+1), (k+2,l+1), and (k+2, l+2). When there is a faulty switching element, it can be bypassed by selecting another available route. FIG. 14 shows an example bypassing a fault module.

The intrinsic characteristic of multiple routes, also, can be used to control the traffic load. When a new traffic is being allowed, the possible routes can be searched for better system performance. FIG. 15 shows the example of avoiding the hot spots to get higher throughput. If there is no route with sufficient traffic capacity, then some hot spots can be controlled by reducing the traffics passing the hot spots.

The switching at each switching element is self-routing which is known by several prior works including the bypassing Omega network also invented by me. There could be two self-routing methods; dynamic self-routing and static self-routing. Dynamic self-routing carries only the destination address and the traffic route will be dynamically decided at each switching element. The destination address will be subtracted from the current address and the difference will be calculated. When there are several different coordinates, one appropriate output direction will be chosen to reduce the difference to the destination. So the routing paths of dynamic routing will vary packet by packet. Static self-routing carries all route information determined at the input protocol processor 510. Each switching elements reads the first or a fixed bit positions to get the routing direction inside the switching element. When a data packet is delivered to the next switching element, the current switching element will change the packet, so that the next switching element also can do the same operation to get the routing direction at the next switching element. The operation to make this regularity can be a shifting of static routing information or counter increment to indicated the next routing bits.

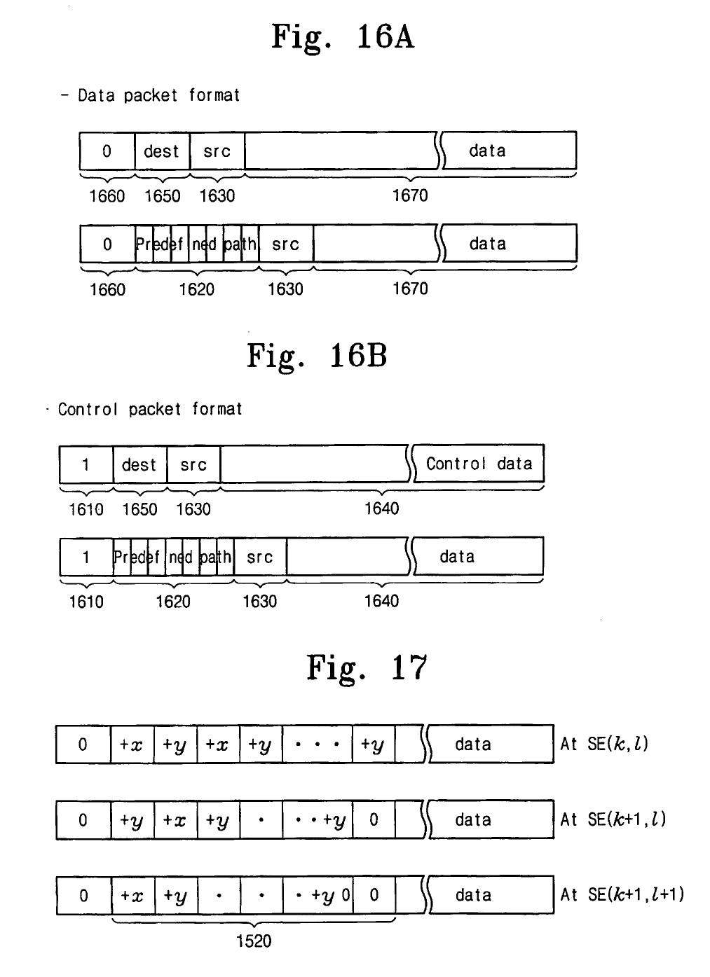

FIGS. 16a and 16b show some possible data packet formats which will travel inside the switching system. The data packet and control packet can be differentiated by a leading bit or bits 1610 1660, which also can be combined with priority information. If the switching system handles dynamic self-routing the packet will contain the destination address or destination coordinates in n-tuple format 1620. There could be several similar embodiments which can be obtained by simple modification from the explained example when an expert wants to implement while following exact the same principle. The traffic packet for static self-routing will have the sequences of routing direction 1620 as shown in FIG. 16.

FIG. 17 shows how the traversing packet data can be changed for self-routing at each switching element on the path \mathring{2} in FIG. 13.

There can be some connections between adjacent output protocol processors. If there is no connection between output protocol processors, then the packet arrived to a surface switching node where a output protocol processor attached should not deliver the data to the nearest output protocol processor if the output protocol processor is not the destination of the packet. For example the traffic packet arriving at node 720e destined to output protocol processor 710b should not be delivered to output protocol processor 710a. Because there is no connection between two protocol processors, 710a and 710b, the packet can not be transferred from output protocol process 710a to output protocol processor 710b. So the dynamic self-routing also may carry the exit direction at the last switching element, which is pointed by destination coordinate 1650. Otherwise the carrying destination coordinate will be that of the target output protocol processor and the surface switching element will recognize somehow itself that it is the surface switching element, and it will adopt the routing limitation not to deliver to the attached protocol processor if the destination coordinate does not match exactly.

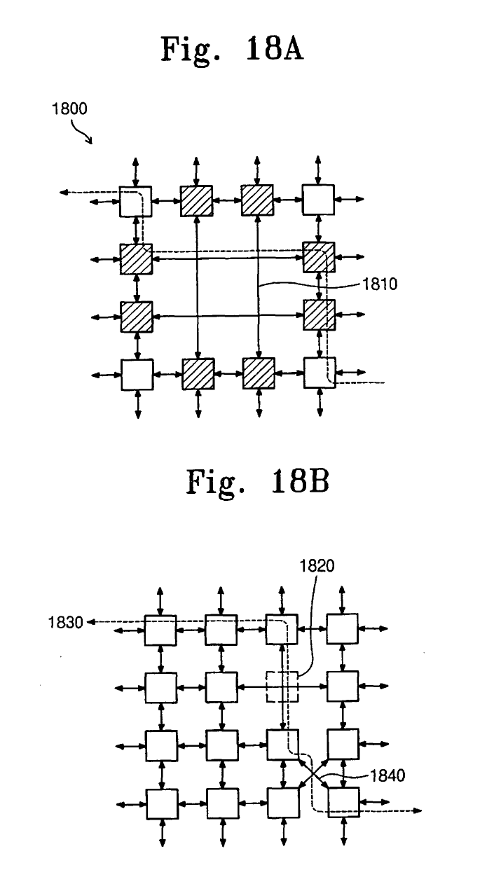

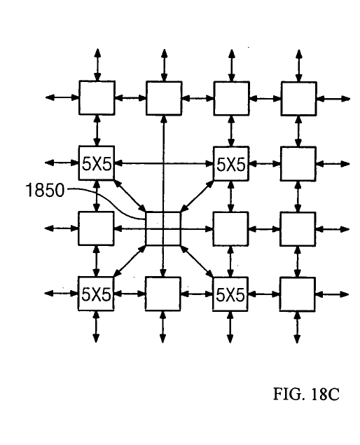

Further reduction on the number of switching elements can be obtained by allowing some irregularity on the internal switching elements connections. FIG. 18a shows the invented broken mesh network with some removed switching elements in the middle of regular connections. The hashed switching elements have far-jumping connections 1810 or others. This irregularity will not cause any serious performance in the system performance or throughput.

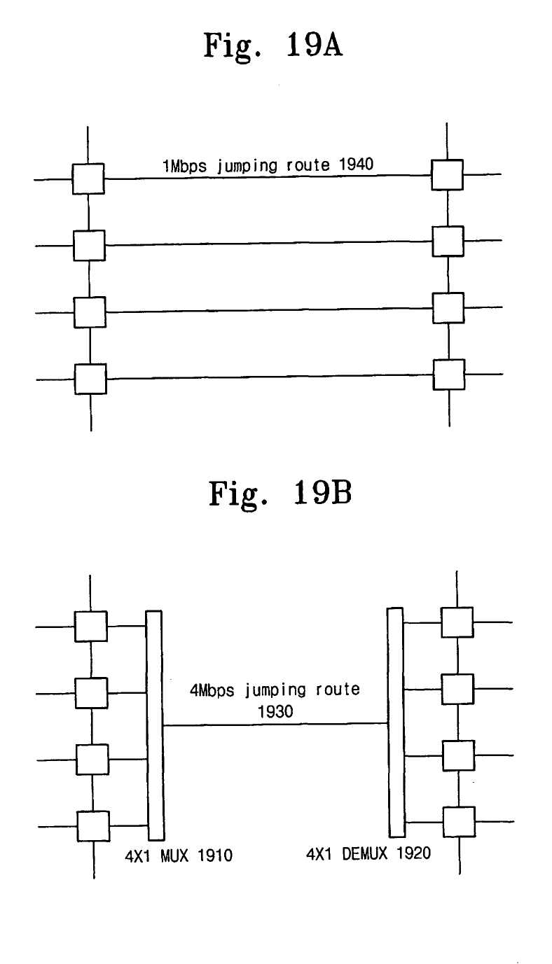

FIG. 18b shows one removed switching element 1820 and two tweaked traffic connections 1840. The example routing 1830 can be done by 5 switching hops, which may take 7 hops if there were no changes 1820 1840. FIG. 18c shows irregular connections. Switching element 1850 has 4 diagonal connections and switching element connected thereto has 5×5 switching operation. A variation of embodiment can be achieved by merging several long jumping routes into a bigger trunk as shown in FIG. 19.

Due to such jumping route and irregular route, self-routing needs to be modified. For dynamic self-routing, each switching element must have coordinate value calculated by the difference between coordinate of a switching element connected to the output of each switching and coordinate of the present switching element. For static self-routing, internal protocol processor or traffic control processor must have information about irregular interconnection. Difference value (delta value) or distance value is 1 or ±1 when there is no jumping route. However, in the presence of jumping route, difference value can be varied. For example, in FIG. 7, switching element 720e has a diagonal jumping route input and output protocol processor 710b and the output terminal of the switching element 720e has a distance value (−1, +1). Namely, the position of the packet traveling through arbitrary output terminal is changed to the extension of the distance value. Each output terminal of the switching element can have a variety of distance value.

As shown in FIG. 19a, a plurality of long jumping routes 1940 can be concentrated. For example, four 1 Mbps long jumping route 1940 can be replaced by 4 Mbps time division multiplexed (TDM) trunk 1930 using 4:1 multiplexer 1910 and 1:4 demultiplexer 1920.

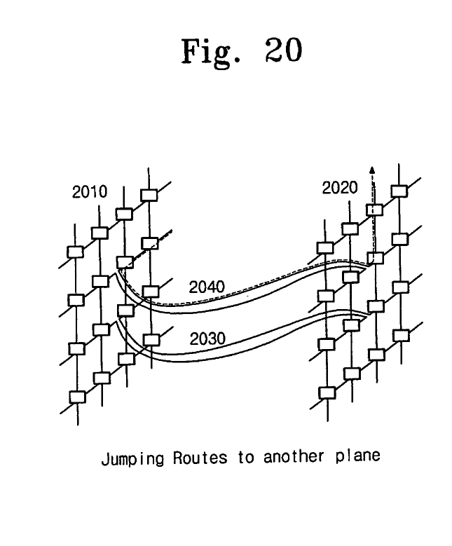

Further increment of input output external links can be achieved by increasing the dangling nodes on the surface of multi-dimensional broken mesh network volume. One embodiment can be connecting several multi-dimensional broken mesh with some irregularities of connection. FIG. 20 shows two switching planes connected by some irregular internal connections 2030 2040. Each switching node has two external traffic connections, the boundary switching nodes have 3 external connections, and the vertex switching nodes have 4 external connections.

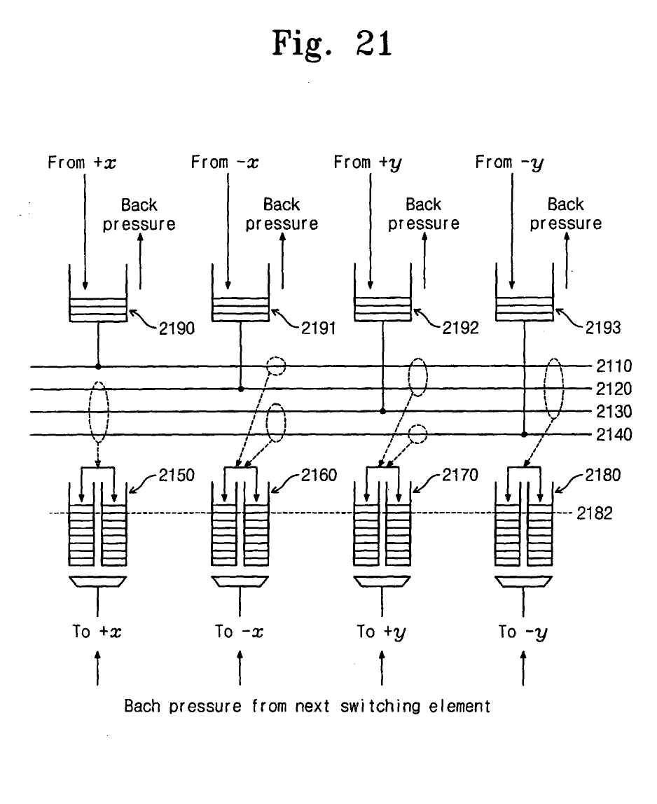

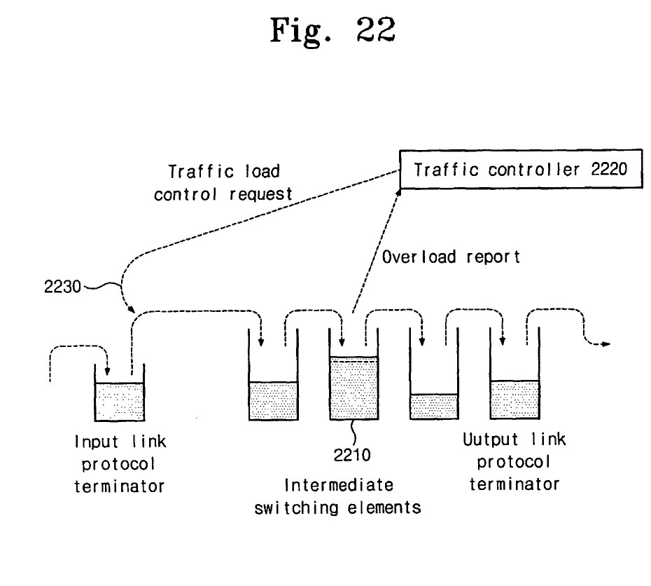

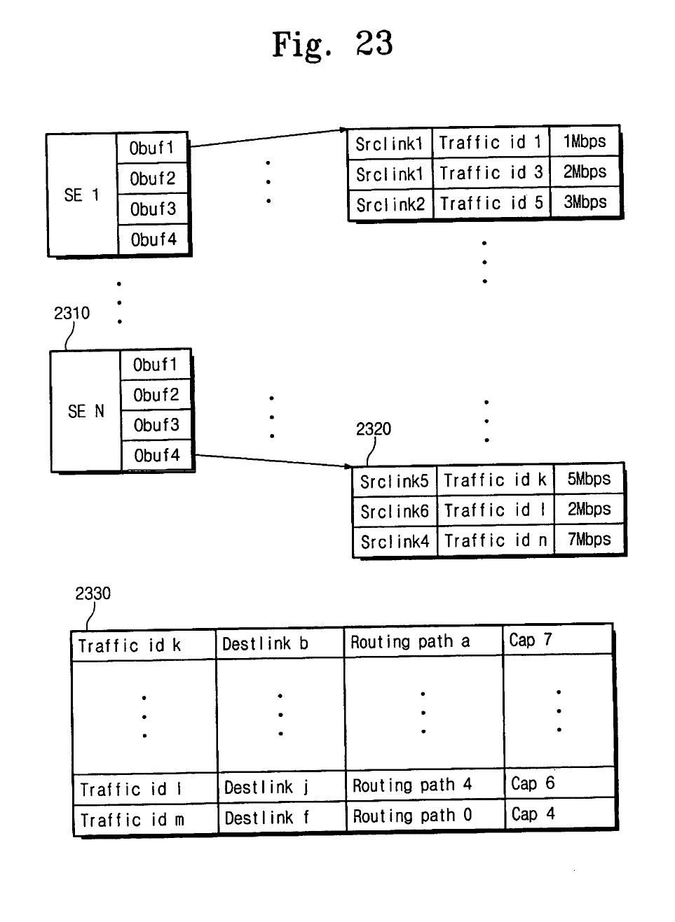

The invented multi-dimensional broken mesh network uses one or several modular switching elements. FIG. 21 shows one embodiment of 4×4 switching element. The switch is designed for two dimensional broken mesh network which has 4 input ports from direction, −x, +x, −y, and +y. There are 4 output directions as same as the input directions. There are 4 input buffers 2190, 2191, 2192, and 2193, which does back pressure to the previous output buffer as 2150, 2151, 2152, and 2153. Each output buffer has a mechanism to detect whether the output buffer level has exceed the water mark of overloading 2182. When a overloading detected at one output buffer the output buffer will be inserted with overloading report control message. The insertion of overloading message can be happen into the overloading output buffer or another buffer with less traffic also. The input buffer can be a dual ported RAM (random access memory) or a single ported memory the writing from input and reading to output happens at each another cycle. Or two or more separated single ported memory can be used and accessed independently at the same time. Even some more variation can be achieved.

One embodiment of the switching element is not to implement the backpressure mechanism between output buffer and input buffer. The output buffer can receive several packets at the same time from different input buffers. When one or more output buffer becomes full, some packets from winning input buffers at the output buffer contention will be discarded with discarded, because they can not be saved into overflowing output buffer. If the system allows the backpressure from output buffer to input buffer, then the traffic load control at the system level will become more important, which will be explained at the later of this document.

There is one unique characteristic in the basic switching element. The traffic from one direction will not go to the same direction, which is explained the dotted circle connected to output buffer 2150. Only traffics from −x 2120, +y 2130 and −y 2140 can go to the +x direction 2150. This characteristic is not unknown but it becomes unique when it is combined with the invented multi-dimensional broken mesh network.

The basic switching element also need to monitor whether any special control message are entered into the input buffer. For example the system can be initialized by propagating the location allocation message. When a local controller of one input buffer reports the entrance of control message to the main controller in the switching element, the main controller will read out the control message and process it. After the processing of a control message, if it is required then the main controller will insert some response, broadcasting or reporting message will be inserted into appropriate output buffers.

All communication traffics need to be under load control for several reasons; authentication, service usage charge, traffic load balancing for better performance at et al. The invented multi-dimensional broken mesh network intrinsically has a good controllability. FIG. 22 shows an example of traffic control in the invented switching network. There are several buffers with many different occupied levels. The output buffer stacks up when the arriving input packets during one packet transfer period are more than one. The input buffer also will stack up if the simultaneously transferable packet number into an output buffer is less than the total input number minus 1 and the input buffer looses at the contention of output buffer request. If there is a backpressure mechanism between input buffer and the previous output buffer, then only monitoring the output buffer would be sufficient to control the system overload. In FIG. 22, the output buffer 2210 becomes overloaded by detecting the overload water mark was passed. Then the overloading information will be reported to the traffic controller 2220. The traffic controller 2220 will request a load reduction requests to all input link protocol processors which have traffics passing through the overloaded output buffer 2210. The input protocol processor may do some traffic load management work, so it can be called as an input link processor.

FIG. 23 shows one possible basic data structure for the traffic load control in the invented system. Each switching element data structure 2310 has all pointers for each output buffer data structure. Each output buffer data structure 2320 has all traffic information, where the traffic information has source link number, traffic identification number at input link processor and the capacitance of allowed traffic. At each input link processor or in the traffic controller, there will be all traffic information 2330 including traffic identification in the switching element and the destination coordinate of output link processor, all routing paths which are assigned to carry the traffic and the allocated capacitance of each routing path. FIG. 23 is just one example data structure of several possible embodiments of invented network system control. This may not be the first or unique enough for claims, but it becomes very unique and powerful claim when it is combined to the invented network system.

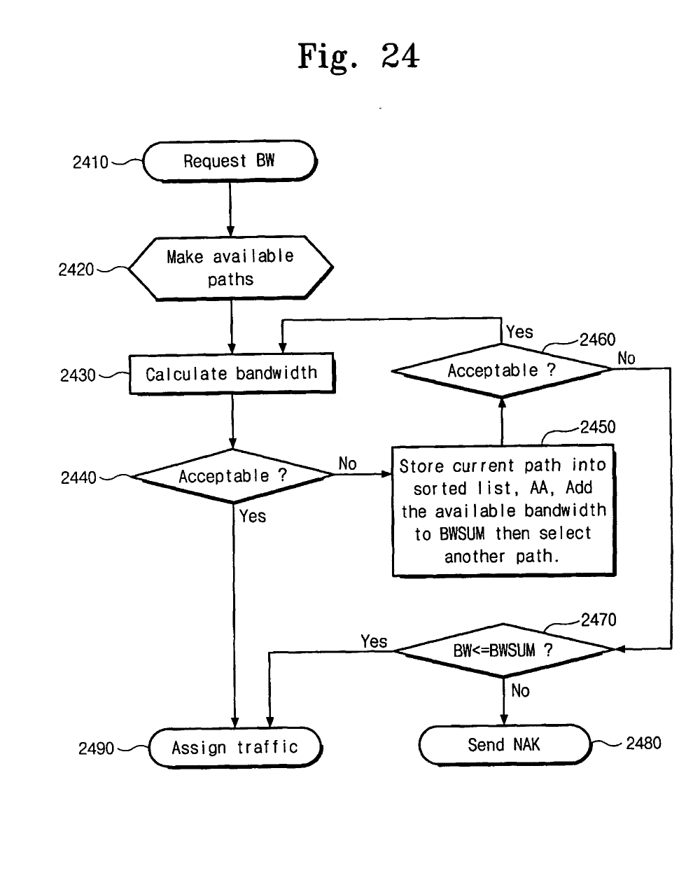

Further example of system load control can be illustrated from FIG. 24. Even though the current internet connection from home is not charged by traffic yet. In some day, all data traffics will be measured and it will be charged based on the usage. To measure the traffic, at the start of any communication the required bandwidth is requested 2410 to the invented switching system residing on the backend of internet. Then the input link processor makes a list of all possible routing paths or some sufficient number of routing paths 2420. For each routing path in the list, the requested bandwidth is evaluated whether it can be carried by the routing path 2430. If the request traffic request can be carried 2440, then the path is assigned to the requested traffic 2490 and the information is stored as described in FIG. 23. Otherwise the examined routing path is stored into sorted list, AA, 2450 and the available bandwidth, BWSUM, is added with the possible bandwidth from the current path. If the list, AA, is empty the BWSUM is the possible bandwidth of the current path. If no sufficient routing path is found and another path is available for search, then the processing loop, 2430, 2440, 2450 or 2490, is re-evaluated. Otherwise the BWSUM is checked against the requested bandwidth BW 2470. If the BW is less than or equal to BWSUM, then the traffic is accepted with several routing paths and the traffic is distributed into several routing paths. If the required bandwidth BW is not available then the requested traffic is discarded and replied with NAK (no acknowledge) 2480. If there is no one sufficient routing path, the algorithm tries to allocate the traffic to the bigger traffic routing routes.

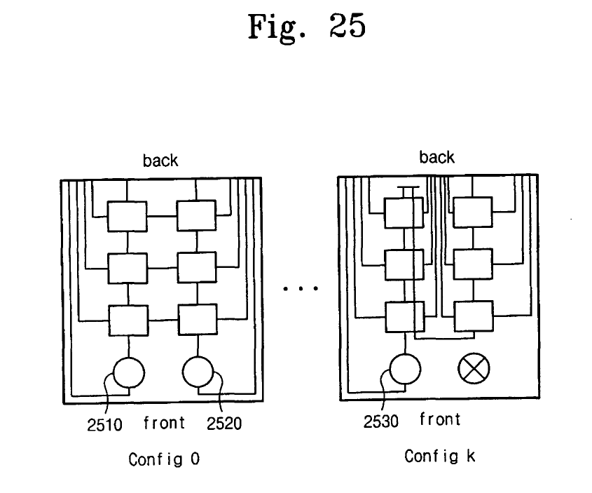

Generally a complex switching system is built on a cabinet style tall rack. If the system is very complex, then it may be built into several racks. The rack is composed of several selves, on which several line cards are installed. The invented system is composed of tightly coupled basic switching elements, which makes difficult to identify a simple modular line card. FIG. 25 shows a configurable line card. There are 6 basic switching elements and two input output link processor. From one line card board, it can be configured into several configurations, such as config(0), . . . , config(k). Config(0) equipped with two input output link processors 2510 2520, but the configuration, config(k) equipped with only one left link processor 2530. The 6 switching elements in config(0) have a parallel connection, but they are connected into serial topology in config(k). Using some limited line card printed circuit boards to make several topology of switching elements will help system builder.

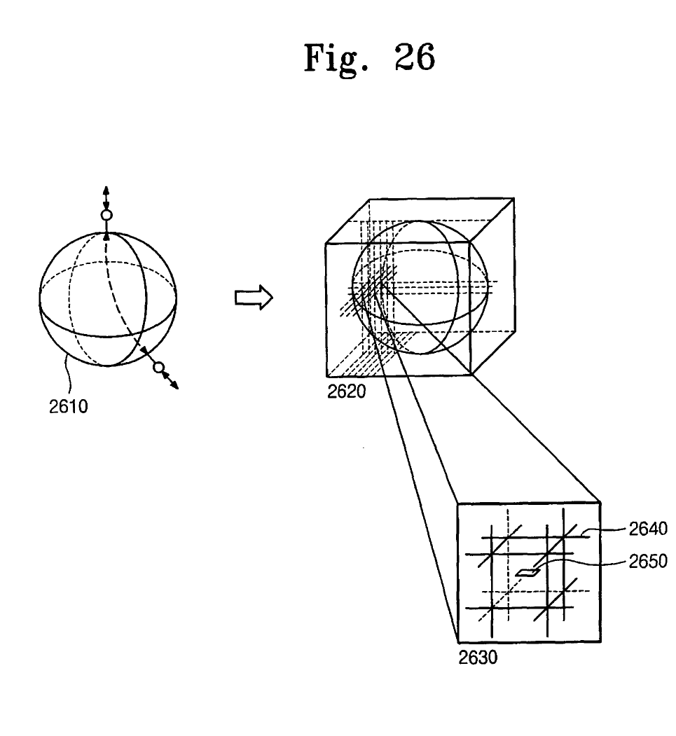

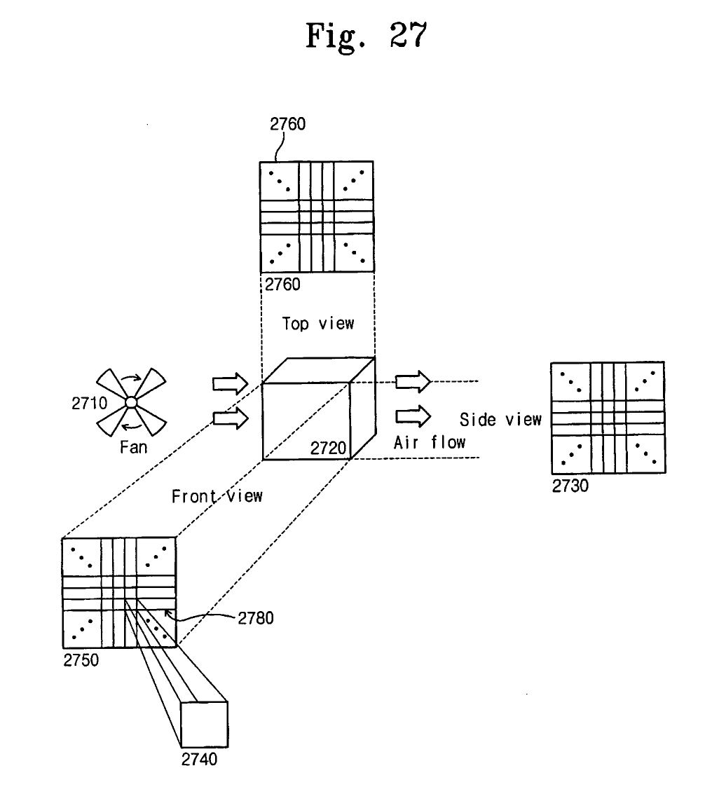

The embodiment of this invention can be implemented when the switching elements are built up into a cell structured three dimensional volume, on the surface of which the traffic links are connected. There will be lots of regular jumping connections inside the volume and each input and output link will be connected with several internal links to reduce traffic load inside the switching elements volume and to increase the fault coverage. FIG. 26 shows a sphere shape switching system 2610 and the cage 2620, which is housing the sphere shape switching system. The three dimensional square shape volume will be composed of three dimensionally stacked cube space cells or xyz selves or frames 2640. Along the three dimensionally placed frames or bars 2640, the routing signal lines will be routed into adjacent switching elements. On the surface of the sphere all external traffic link will be connected. And the traffic data will be routed through normal disconnected mesh network or jumping routes. One example routing path is shown in FIG. 26 with curved trace 2610. Each switching board 2650 mounting one or more switching elements is placed into one cube cell 2630 of the housing cage. Each switching board is mounted in the cube cell through socket and wiring is formed to the socket along the frame 2640. Cube cell 2630 assembles together to form a square volume 2620. Some of the cube cell located at corner can be removed to form sphere shaped switching system.

Invented unique system housing method achieves good fault maintenance and system cooling. FIG. 27 shows several views of the invented three dimensional system housing 2720. There is a system cooling fan 2710 making the air flow from left to the right taking away the generated heats from switching element. The system can be implemented into several subsystems with same structure as shown in FIG. 27. The switching elements are attached to the selves or bars 2780 which also used as a guide structure of signal routing wires. These frames also can be used for system cooling by passing through a coolant inside the frame or connected to the low temperature object, so that the frame itself carries out the heat generated in the middle of the three dimensional volume cage.

The front view 2750 shows the vertical and horizontal frames making a space for the mounting of switching elements or modules. The space of each one cell 2740 can be spacious reasonably. This space can be used to replace a faulty switching element on-the-fly using my human arm, micro-machine or the other apparatuses. The side view 2730 also shows some space per cell structure, so that the cooling air can be easily moved away with system heat. The top view 2760 shows the switching element or module which composing the invented switching system.

All trunk lines of the invented system need to be connected to the surface of switching system volume. If it is physically connected on the evenly distributed surface points, then it can be obstacle for the system maintenance. One way is to connect from the evenly distributed points, by using another segment of wire to collect the physical connection point of input output trunk. For example, if there are 100 pints of input output link connection are on the front surface 2720, those 100 links can be physically collected to the lower right corner of the front surface 2750.

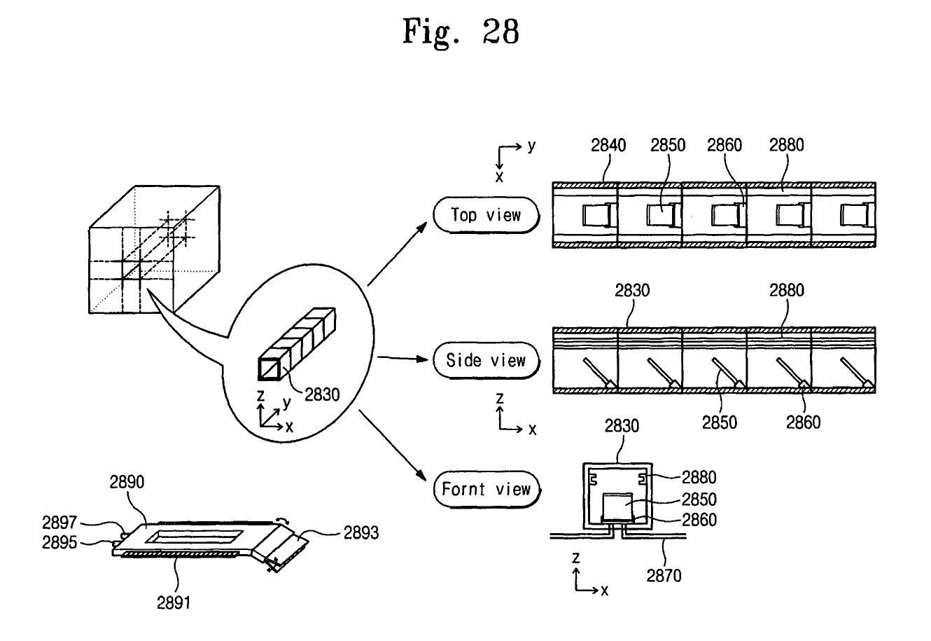

FIG. 28 schematically illustrates three dimensional housing in FIG. 26 with switching board and socket and guide means for guiding exchange apparatus. Referring to FIG. 28, switching board mounting one or more switching element is mounted in the cube cell 2830 though socket 2860 and wiring 2870 is formed to the socket 2860 along the frame 2840. Guide means 2880 is formed in each cell 2830. Guide means 2880 is a kind of rail and is formed upper sidewall of the cell 2830. Exchange means 2890 is inserted into the guide means 2880 and moves back and forth along the guide means 2880. Exchange means 2890 comprises an inserting part 2891 inserted into the guide means 2880, holding part 2893 for holding the switching board, and moving means 2895, 2897 for moving the holding part 2893 to hold the switching board. The moving means 2895, 2897 can be made of screw. Depending on the direction of the screw, the holding part 2893 moves up and down, back and forth. After the exchange apparatus 2890 is inserted in the guide means 2880, the exchange apparatus 2890 moves toward the switching board to be exchanged. Moving means 2895, 2897 is then manipulated to open the holding part 2893 and hold the switching board. After holing the switching board, the exchange 2890 moves back out of the guide means 2880.

In the various embodiments of this invention, novel structures and methods have been described for an efficient packet switching system. The various embodiments of the structures and methods of this invention that are described above are an exemplary of the principles of this invention and are not intended to limit the scope of the invention to the particular embodiments described. For example, in the view of this disclosure, those skilled in the art can define other expression of surface and jumping routes, system load control methods, switching element reduction methods, connection methods of several invented architecture, system element co-packaging method, several switching element partitioning, system element housing method, system cooling method and so forth, and use these alternative features to create a method or system according to the principles of this invention. Thus the invention is limited only by the following claims.

1. An n-dimensional broken mesh network comprising:
broken links which is generated by breaking connections between a starting switching element of each dimension and an ending switching element of each dimension;
input output protocol processing blocks connected to the broken links;
external traffic links connected to the input output protocol processing blocks,
wherein each switching element is identified by n-tuple coordinates, (d1, d2, . . . , dn), and there are connections between two switching elements having n−1 same coordinates and the other coordinate is different only plus minus one, ±1, when the coordinates are numbered monotone increasing way by increment 1.

2. The n-dimensional broken mesh network of claim 1, further comprising system control processors connected to the broken links.

3. The n-dimensional broken mesh network of claim 2, further comprising jumping routes which increase a number of input and output terminals in the switching element, wherein the jumping routes provides a connection between a switching element and other element having n−1 same coordinates and the other coordinate is different only plus minus one, ±1, when the coordinates are numbered monotone increasing way by increment 1, wherein other element comprises a switching element, input output protocol processor, or system control processor.

4. The n-dimensional broken mesh network of claim 2, wherein the system control processors are connected by a control system bus.

5. The n-dimensional broken mesh network of claim 4, further comprising jumping routes which increase a number of input and output terminals in the switching element, wherein the jumping routes provides a connection between a switching element and other element having n−1 same coordinates and the other coordinate is different only plus minus one, ±1, when the coordinates are numbered monotone increasing way by increment 1, wherein other element comprises a switching element, input output protocol processor, or system control processor.

6. The n-dimensional broken mesh network of any one of claims 1, further comprising jumping routes which increase a number of input and output terminals in the switching element, wherein the jumping routes provides a connection between a switching element and other element having n−1 same coordinates and the other coordinate is different only plus minus one, ±1, when the coordinates are numbered monotone increasing way by increment 1, wherein other element comprises a switching element, input output protocol processor, or system control processor.

7. The n-dimensional broken mesh network of claim 6, wherein internal switching elements are removed and adjacent elements are connected, or surface switching elements are removed and the input output protocol processors are connected to the link which is connected to the removed surface switching elements.

8. The n-dimensional broken mesh network of claim 7, wherein connection between two switching elements having n−1 same coordinates and the other coordinate is different only plus minus one, ±1.

9. The n-dimensional broken mesh network of claim 7, wherein the input output protocol processor is connected to at least one of the switching element through the broken link or jumping route.

10. The n-dimensional broken mesh network of claim 7, wherein the system control processor is connected to at least one of the switching element through the broken link or jumping route.

11. The n-dimensional broken mesh network of claim 8, wherein the input output protocol processor is connected to at least one of the switching element through the broken link or jumping route.

12. The n-dimensional broken mesh network of claim 8, wherein the system control processor is connected to at least one of the switching element through the broken link or jumping route.

13. The n-dimensional broken mesh network of claim 5, wherein each switching element comprises a switching controller, an input buffer with an input buffer monitor, an output buffer, wherein the switching controller processes a control packet when the control packet is entered into the input buffer.

14. The n-dimensional broken mesh network of claim 13, wherein each output buffer has an output buffer monitor, wherein when the output buffer is overloaded, the output buffer monitor reports to the switching controller to insert reporting data which is destined to the system control process into the output buffer or other output buffer.

15. The n-dimensional broken mesh network of claim 13, wherein the result of the processing the control packed by the switching controller is stored into arbitrary output buffer.

16. The n-dimensional broken mesh network of claim 13, wherein each switching element carries out dynamic self-routing.

17. The n-dimensional broken mesh network of claim 16, wherein if there is a packet to be delivered to a full output buffer, the packed is discarded when the packed is entered or the packed is in the front of the input buffer for routing.

18. The n-dimensional broken mesh network of claim 16, wherein the packet in the front line of the input buffer (FIFO) is discarded, if there is no available output buffer for the next packet destination with available packet buffer space.

19. The n-dimensional broken mesh network of claim 13, wherein the switching element stores the distance delta value of each jumping route to the switching element connected though the jumping route in the n-tuple delta values as (Δ1, Δ2, . . . , Δn), in list form of (axis direction, delta value), or in the list form of delta value for the fixed axis's in the system.

20. The n-dimensional broken mesh network of claim 13, wherein the input protocol processor, system control processor, or the switching elements has the information of the jumping routes in the form of n-tuple delta value as (Δ1, Δ2, . . . , Δn), in list form of (axis direction, delta value), or in the list form of delta value for the fixed axis's in the system.

21. The n-dimensional broken mesh network of claim 8, wherein each switching element or a plurality of switching elements is mounted on a switching board, and the switching board is mounted on a unit cell through a socket, and wherein the unit cell is defined by n-tuple frames which are arranged in corresponding dimension, a wiring is formed along the frames to the socket.

22. The n-dimensional broken mesh network of claim 21, wherein coolant is flow inside the frame or the frame is in contact with a low temperature object.

23. The n-dimensional broken mesh network of claim 9, wherein each switching element or a plurality of switching elements is mounted on a switching board, and the switching board is mounted on a unit cell through a socket, and wherein the unit cell is defined by n-tuple frames which are arranged in corresponding dimension, a wiring is formed along the frames to the socket.

24. The n-dimensional broken mesh network of claim 10, wherein each switching element or a plurality of switching elements is mounted on a switching board, and the switching board is mounted on a unit cell through a socket, and wherein the unit cell is defined by n-tuple frames which are arranged in corresponding dimension, a wiring is formed along the frames to the socket.

25. A switching system comprising:
n-dimensionally arranged frames;
n-dimensional unit cells defined by n-tuple frames of each dimension; and
switching boards mounted in unit cell, wherein a protocol processing block is connected to the switching boards mounted in unit cells located at outer surface or located interior remote from the outer surface are connected to a input output protocol processing block, and an outer traffic link is connected to the input output processing block.

26. The switching system of claim 25, wherein some of the unit cells does not have the switching board.

27. The switching system of Clam 25, wherein each unit cells has a guide means on a surface or a corner of the frame for guiding an exchange apparatus for exchanging switching board.
